(19) United States
(12) Patent Application Publication
(10) Pub. No.: US 2024/0149486 A1
(43) Pub. Date: May 9, 2024

(54) LOG PUSHER

(71) Applicant: George H. GOATER, Delta (CA)

(72) Inventor: George H. GOATER, Delta (CA)

(21) Appl. No.: 18/052,923

(22) Filed: Nov. 6, 2022

(51) Int. Cl. B27B 31/06

(52) U.S. Cl. CPC B27B 31/06

(57) ABSTRACT

There is provided a log processing assembly including an elongate member. The assembly includes a lifting device which couples to and extends radially outwards from the elongate member. The assembly includes a pair of spaced-apart wall members between which the lifting device extends. The assembly includes an external, radial actuating driving mechanism which operatively connects to and actuates the elongate member so as to reciprocate the lifting device through a curved range of motion spanning from lowered to raised positions. The driving mechanism is positioned external to said wall members. The assembly includes a lifting device and a counterweight. The counterweight rotates about an axis parallel to and spaced-apart from an axis of rotation of the lifting device.

### BACKGROUND OF THE INVENTION

### Field of the Invention

There is provided a log processing assembly. In particular, there is provided a log pusher.

### Description of the Related Art

Log pushers have unique functions to improve overall sawmill efficiency in the short log handling process. This function is to control randomly delivered logs (occasionally several at a time) exiting longitudinally out of a conveyor at high speed from a previous process onto a hopper skid. Occasionally, the hopper also accepts logs from the back side delivered from a separate infeed log deck, operated to avoid simultaneous log delivery. The log(s) then skid to a stop, and allow gravity to arrange the log(s) on the hopper sloping skid. The logs are then ready for loading onto the log lifting surface in its down position, to be elevated up the barrier plate, and discharged onto the take-away deck.

The function of a log pusher is to supply a correctly oriented and regulated supply of logs, usually to a debarker line or canter infeed log decks. The width of the log pusher will normally be designed for short wood that is bucked to length, either in the woods, or at the sawmill. A non-limiting example of a log pusher is shown in U.S. Pat. No. 5,119,930 to Stelter.

Logging has become more and more prevalent in southern climates, including logging of southern yellow pine. Such logs may differ from the logs of more northerthly climates in a variety of ways. The wood on average may be much denser, approx 50% heavier for example. The tree diameters on average may be larger, making most logs much heavier. The limbs (knots) may on average be larger. The logs may contain vines wrapped around the unbarked log. The form or shape of the log may on average be much poorer (irregular shape), increasing the need for accomodating equipment. The hot weather may also dictate the elimination of outdoor physical activity as much as possible, requiring reliable log handling equipment.

Also, log pusher performance and general mill productivity expectations have been raised due to the modernization of southern sawmills. There may thus be a need to process logs faster, remove debris from beneath the log pusher more reliably, handle vines better, eliminate/reduce drive/mechanism damage, spend less time maintaining and cleaning the log pusher, simplify the log pusher support structure, elevate the log from the infeed hopper elevation onto the take-a-way transfer deck consistently and oriented correctly, provide an electric drive for efficiency and less enviromental impact, provide more robust and reliable log pusher designs.

### BRIEF SUMMARY OF INVENTION

There is provided, and it is an object to provide, an improved log processing assembly, in this example a log pusher, disclosed herein.

There is provided a log processing assembly according to a first aspect. The log processing assembly includes an elongate member. The log processing assembly includes a lifting device which couples to and extends radially outwards from the elongate member. The log processing assembly includes a pair of spaced-apart wall members between which the lifting device extends. The log processing assembly includes an external, radial actuating driving mechanism which operatively connects to and actuates the elongate member so as to reciprocate the lifting device through a curved range of motion spanning from lowered to raised positions. The driving mechanism is positioned external to said wall members.

There is also provided a log processing assembly according to another aspect. The log processing assembly includes a pair of spaced-apart wall members. The log processing assembly includes one or more truss-type structures coupled to and extending between the wall members. The log processing assembly includes a lifting device coupled to, extending between and moveable relative to the wall members. The log processing assembly includes a driving mechanism which operatively connects to and reciprocates the lifting device through a range of motion spanning from lowered to raised positions.

There is further provided a log processing assembly according to a further aspect. The log processing assembly includes a driving mechanism. The log processing assembly includes a lifting device and a counterweight configured to oscillate in opposite directions from one another via the driving mechanism. The counterweight rotates about an axis parallel to and spaced-apart from an axis of rotation of the lifting device.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention.

FIG. 1 is a front, left side perspective view of a log pusher according to one aspect, the log pusher including a lifting device shown in a partially raised position and the log pusher being shown above a conveyor seen in fragment;

FIG. 2 is a rear, right side perspective view of the log pusher of FIG. 1, with the conveyor of FIG. 1 not being shown;

FIG. 3 is a lateral sectional view of the log pusher of FIG. 1, with the lifting device shown in a fully lowered positioned;

FIG. 4 is a lateral sectional view taken along lines 4-4 of the log pusher of FIG. 1;

FIG. 5 is a lateral sectional view of the log pusher of FIG. 1 with the lifting device shown in a fully raised position;

FIG. 6 is a lateral sectional view taken along lines 6-6 of the log pusher of FIG. 1;

FIG. 7 is a front, left side perspective fragmented view of the log pusher of FIG. 5, showing a drive and actuating mechanism thereof, together with the lifting device thereof and counterweight thereof, with the rest of the log pusher not being shown;

FIG. 8 is a rear elevation fragmented view of the log pusher, including a guiding barrier thereof shown coupled to a sprocket of a take-away deck;

FIG. 9 is a sectional, rear, right side fragmented view taken along lines 9-9 of the log pusher and take-away deck of FIG. 9;

FIG. 10 is a front elevation view of a counterweight and actuating mechanism of the log pusher of FIG. 1, with the counterweight and an equalizer tube of the log pusher being shown in fragment and with the rest of the log pusher not being shown; and

FIG. 11 is an exploded fragmented view of the lifting device of the log pusher of FIG. 1, with the rest of the log pusher not being shown.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

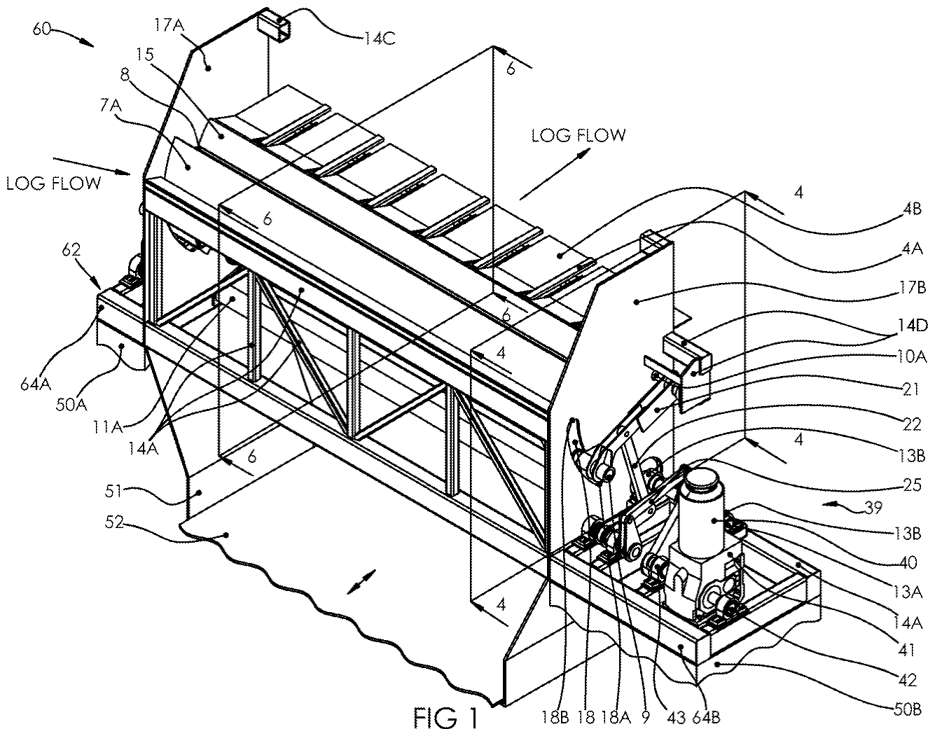

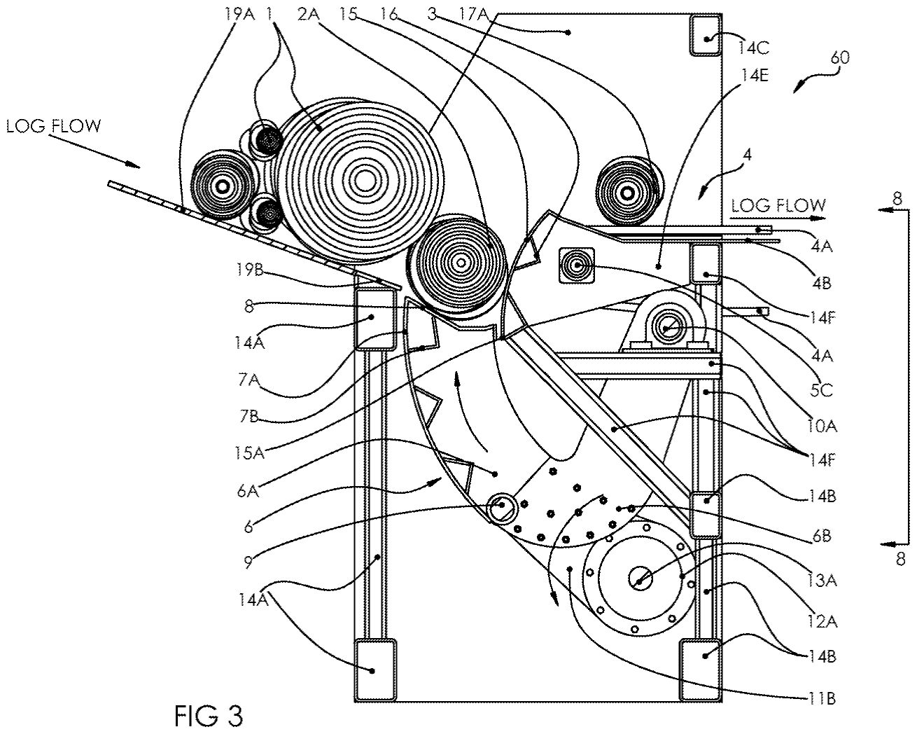

Referring to the drawings and first to FIG. 1, there is shown a log processing assembly, in this example a log pusher 60. The log pusher basically operates as follows. Referring to FIG. 3, log pusher 60 receives logs 1 from a typical hopper landing and infeed skid 19A/19B. The log pusher includes an elongate member, in this example a lifting/mechanism arm pivot shaft 10A. The pivot shaft is longitudinally extending. Log pusher 60 includes at least one lifting device, in this example one or more longitudinally spaced-apart and laterally/radially-extending lifting arms 6 coupled to and extending radially outwards from the pivot shaft. The lifting arms are positioned adjacent to respective sides of log pusher 60 in this example. The lifting device or lifting arms 6 rotate about a pivot point as defined by pivot shaft 10A.

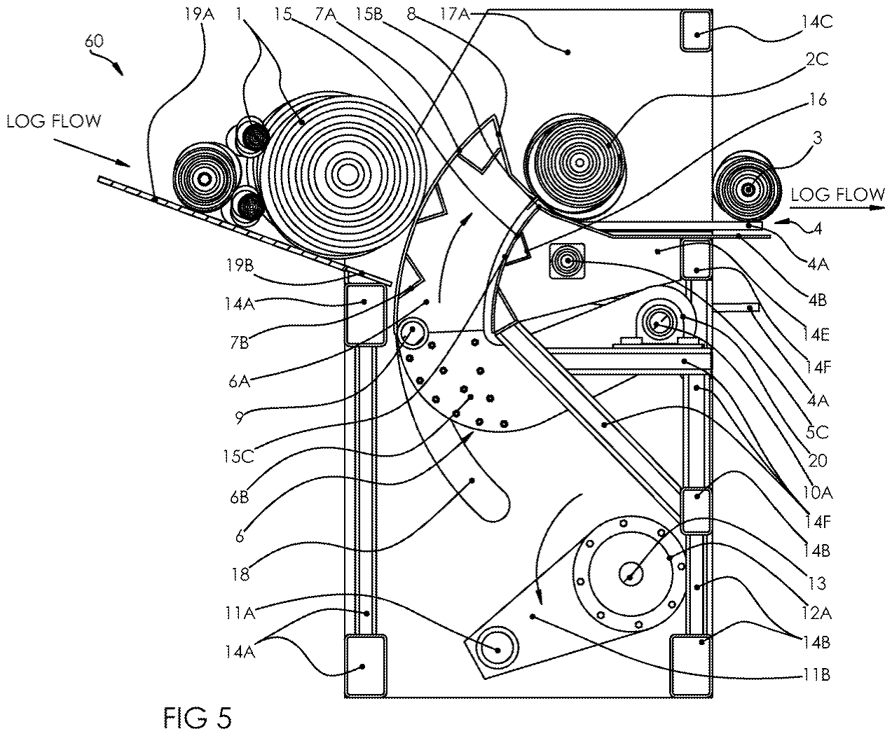

The lifting arms move logs 2A from a first or fully lowered positioned seen in FIG. 3 to a second or fully raised position angularly spaced from the lowered position and seen in FIG. 5, where log 2C is deposited onto a take-away deck 4, which includes a take-away deck chain 4A and take-away deck plate 4B. Log 3 is then transferred to the next process. Take-away deck plate 4B comprises a standard design of decks to prevent short logs from falling between deck chains 4A.

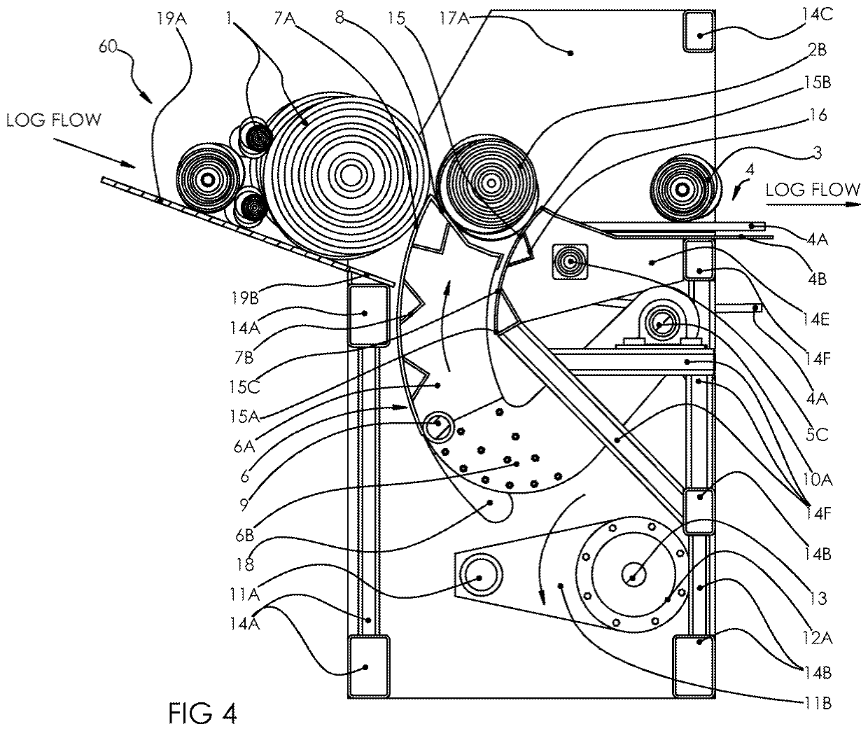

As seen in FIG. 4, log pusher 60 includes a counterweight or counterbalance weight 11A and one or more counterbalance arms 11B. Lifting arms 6 and counterbalance weight 11A are configured to substantially align vertically with each other in this example. The lifting arms and counterweight arm are configured to oscillate in opposite directions from one another as seen in FIGS. 3 to 5. Counterbalance weight 11A and counterbalance arm may be individually or collectively referred to as a counterweight.

In one non-limiting example of normal process requirements of a balanced single acting log pusher: the basic sawlog length may be 8′ to 24′ logs that are unbarked/debarked, with one size for 5″-30″ diameter logs (nominal log envelope). One basic design of log pusher may but need not have a nominal speed of approximately 15 CPM.

Log pusher 60 and its various components will now be discussed in greater detail. As seen in FIG. 1, the log pusher includes lower frame assembly 62 with spaced-apart end portions 64A and 64B that are load-bearing. The lower frame assembly is rectangular in this example and the end portions of the lower frame assembly are shaped to extend along respective support structures 50A and 50B. The support structures are configured to support log pusher 60 at both ends of the log pusher.

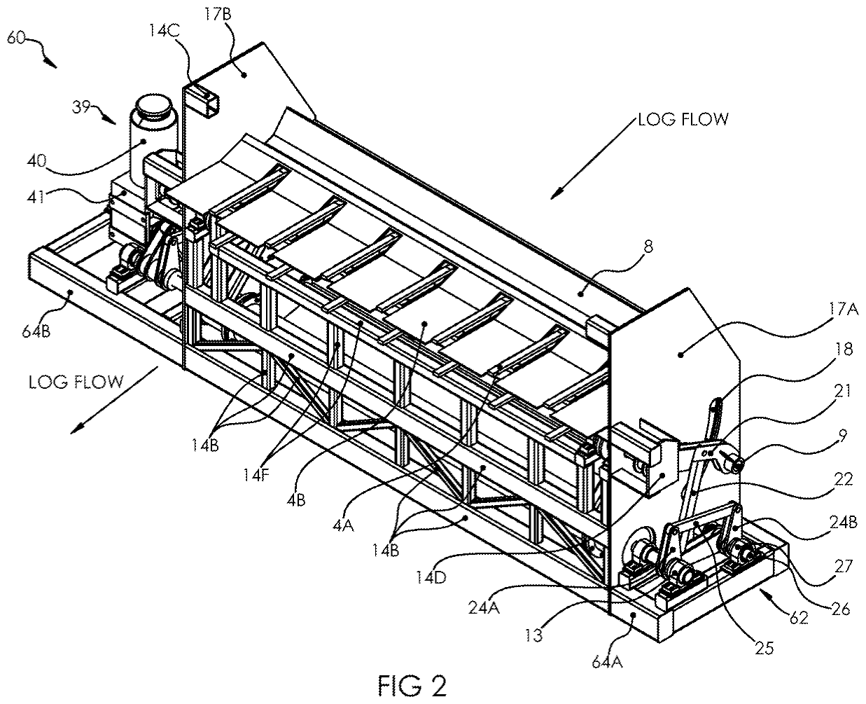

The log pusher includes at least one and in this example a pair of truss-type structures or truss assemblies, in this case a first truss-type structure or first truss assembly 14A seen in FIG. 1 and a second truss-type structure or second truss assembly 14B seen in FIG. 2, coupled to and spaced-apart from the first truss assembly. The truss assemblies couple to and extend between end portions 64A and 64B of lower frame assembly 62. Referring back to FIG. 1, first truss assembly 14A couples to and extends along the front of the lower frame assembly and second truss assembly 14B, seen in FIG. 2, couples to and extends along the rear of the lower frame assembly in this example. The first and second truss assemblies may be referred to as infeed structural truss components and outfeed structural components, respectively. Truss assemblies 14A and 14B comprise structural members that form free spanning trusses at the infeed and outfeed of log pusher 60.

As seen in FIG. 3, first trust assembly 14A is shaped to support thereon hopper landing and infeed skid 19A as well as a pusher infeed skid 19B. The hopper landing and infeed skid comprises an infeed skid plate of the landing hopper, and pusher infeed skid comprises an infeed skid plate of log pusher 60. Skids 19A and 19B are shaped to receive a pile of incoming logs 1.

As seen in FIG. 1, take-away conveyor belt 52 is positioned below log pusher 60 to transport wood debris away from under the log pusher. The take-away conveyor belt is positioned between end portions 64A and 64B of lower frame assembly 62 of the log pusher. Clean-up conveyor troughing 51 extends upwards from take-away conveyor belt 52 to receive wood debris therebetween and direct said wood debris to the conveyor belt.

Still referring to FIG. 1, log pusher 60 includes a pair of spaced-apart wall members, in this example bin walls 17A and 17B. The bin walls each comprise a structural wall that separates the log processing components from the mechanism/drive of log pusher 60. At least one and in this example each bin wall 17A has an aperture or opening, in this example an arc-shaped slot 18 extending therethrough; however the latter is not strictly required and in other embodiments there may be provided an enlarged or circular or semi-circular aperture or opening for example. The slots may be referred to as curved bin wall slots. Slots 18 are positioned between the top and bottom of log pusher 60, from adjacent the front of the log pusher towards the bottom and rear of the log pusher in this example. Each slot has a radius of curvature. Each bin wall 17A includes a pair of spaced-apart and outwardly concave end portions, in this example lower end portion 18A and upper end portion 18B in communication with slot 18 thereof. End portions 18A and 18B of slots 18 are located to avoid intruding on the active area inside of bin walls 17A and 17B.

Clean-up conveyor troughing 51 is shaped to substantially align with bin walls 17A and 17B in this example. Log pusher 60 includes a bin wall stiffening member 14C which couples to and extends between the bin walls. The bin wall stiffening member extends horizontally in this example and comprises a cross member to stiffen the bin walls. Bin wall stiffening member 14C is positioned to be higher than a predetermined maximum diameter log to be processed by log pusher 60, with the bin wall stiffening member in this example being positioned towards the top and rear of the log pusher.

Bin walls 17A and 17B couple to and extend upwards from lower frame assembly 62 adjacent end portions 64A and 64B of the lower frame assembly. Truss assemblies 14A and 14B seen in FIGS. 1 and 2 and the bin walls couple to and extend upwards from lower frame assembly 62. The truss assemblies couple to and extends between the bin walls. Bin walls 17A and 17B couple to and extend between the front and rear of lower frame assembly 62. Log pusher 60 is configured to enable all internal loads to be transferred out-to bin walls 17A and 17B. Referring to FIGS. 1 and 2, built in structural trusses or truss assemblies 14A and 14B at both the infeed and outfeed ends of log pusher 60, with all the internal loads transferred out-to the bin walls, enable the log pusher to be freestanding.

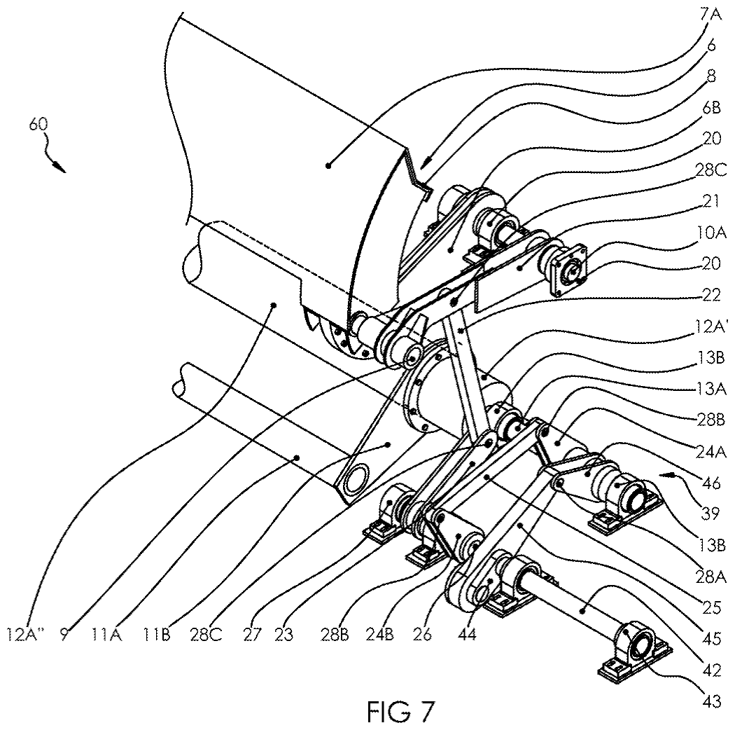

As seen with reference to FIGS. 5 and 7, lifting arms 6 will now be discussed in more detail. Lifting/mechanism arm pivot shaft 10A pivotally couples to truss assembly 14B via plurality of longitudinally spaced-apart lifting arm/mechanism arm pivoting bearings 20. The bearings function to provide the shaft with substantially identical rotation. Pivot shaft 10A is the shaft around which both lifting arm 6 and mechanism pivot on bearings 20. As seen in FIG. 1, log pusher 60 includes a pair of actuating arm support brackets 14D coupled and extending longitudinally outwards from respective bin walls 17A and 17B. The actuating arm support brackets are positioned between the top and bottom of the log pusher along the rear of the log pusher in this example. Each actuating arm support bracket functions as a bearing support bracket for its respective/adjacent actuating arm 6 seen in FIG. 3.

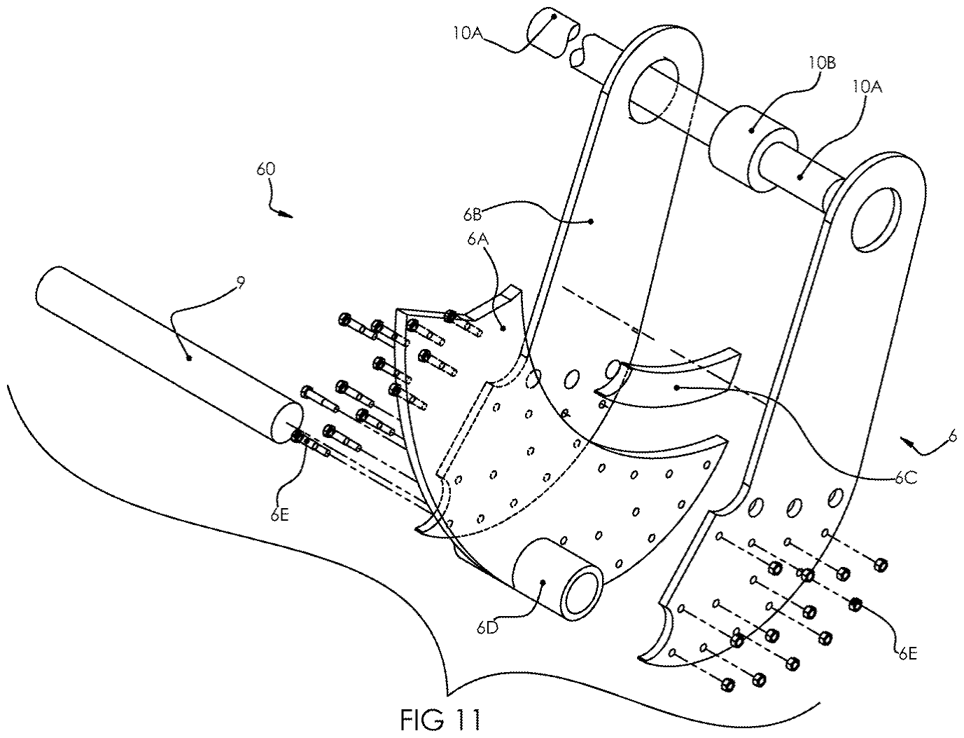

Lifting arms 6 seen in FIG. 3 are positioned between bin walls 17A and 17B seen in FIG. 1. As seen in FIG. 11, each lifting arm includes at least one and in this example a pair of pivoting components 6B through which pivot shaft 10A extends at proximal ends thereof. The pivoting components couple to and extend radially/perpendicularly outwards from pivot shaft 10A via a lifting arm hub 10B on the pivot shaft. As seen in FIG. 3, each lifting arm 6 includes a second or elevating component 6A which functions to elevate one or more logs 2A to take-away deck 4. Pivoting components 6B of lifting arm 6 function to connect pivot bearings 20 to the elevating component of the lifting arm. Elevating component 6A is arcuate-shaped in this example. As seen in FIG. 11, hub 10B connects pivot shaft 10A to elevating component 6A via pivoting components 6B. Still referring to FIG. 11, each lifting arm 6 includes in this example an impact plate 6C positioned between pivoting components 6B thereof. The impact plate functions to assist in transferring the log impact loads back to bearings 20 seen in FIG. 5.

Referring back to FIG. 11, log pusher 60 includes a connecting member or bar 9 which couples together longitudinally spaced-apart lifting arms 6. The connecting bar is longitudinally-extending and extends parallel to pivot shaft 10A in this example. Each elevating component 6A includes at least one and in this example a pair of longitudinally-extending lifting arm hubs 6D coupled thereto. The hubs include a pair of opposed receptacles for receiving one or more connecting bars 9 therein. The lifting forces are transferred to lifting arms 6 through hubs 6D. Referring to FIG. 3, the distance between connecting bar 9 and pivot point of lifting arms 6 as defined by pivot shaft 10A, is substantially equal to the radius of curvature of slots 18 seen in FIG. 1 in this example. As seen in FIGS. 2 and 7, end portions of connecting bar pivotally couple to corresponding pivot shafts 10A via respective link or mechanism actuating arms 21.

As seen in FIG. 1, connecting bar 9 is shaped to extend through and move along a path formed by slots 18 bin walls 17A and 17B. Slots 18 are curved openings in the bin walls shaped to accommodate the connecting bar. The slots are shaped to receive respective end portions of connecting bar 9 therethrough, with said end portions thus being external of bin walls 17A and 17B. Referring to FIG. 1, the connecting bar is adjacent lower end portions 18A of bin walls 17A and 17B when lifting arms 6 are in their fully lowered position seen in FIG. 3. Connecting bar 9 is adjacent upper end portions 18B of the bin walls seen in FIG. 1 when the lifting arms are in their fully raised position as seen in FIG. 5. Referring to FIGS. 3 and 5, lifting arms 6 thus slidably couple to, extend between and are moveable relative to bin walls 17B. Referring to FIG. 1, the log lifting/lowering motion is transferred from the external mechanisms (described in more detail below) to lifting arms 6 via short shafts or connecting bars 9 passing through bin walls 17A and 17B in curved slots 18 at each side of the bin walls. Referring to FIG. 7, connecting bar 9 connects the lifting arms to the external mechanism of log pusher 60 through the bin walls and is selectively removable in part for installation and repairs purposes for example.

As seen in FIG. 11, the proximal end of elevating component 6A and distal ends of pivoting components 6B are selectively connectable together and removable from each other via fasteners, in this example in the form of nuts and bolts 6E. Each lifting arm 6 is thus made of two pieces or components. The two piece bolted design may enable efficient assembly and convenient repair of lifting arms 6 or components thereof in the event of major damage. Elevating component 6A is bolted to pivoting component 6B in its final position, to facilitate assembly and replacement. Nuts and bolts 6E may thus function to selectively connect the lifting arms together during assembly of log pusher 60 and enable lifting arms or components thereof to be selectively disconnected as needed for repairs and the like. It may be difficult to log pusher 60 so configured without a bolted connection.

As seen in FIG. 3, each lifting arm 6 is C or U-shaped in side profile when so coupled together in this example. The lifting arms may be referred to as internal lifting arms.

As seen in FIG. 7, log pusher 60 includes a front arcuate shaped planar member, in this example a front wall 7A which is part of the lifting device thereof. The front wall is longitudinally extending and couples to lifting arms 6. Front wall 7A is outwardly convex in this example and may be referred to a working arc surface. Alternatively, the front wall may be referred to as an outwardly convex front face. Front wall 7A extends parallel to pivot shaft 10A and connecting bar 9. The front wall is centered on the pivot axis of lifting arms 6 as defined by pivot shaft 10A.

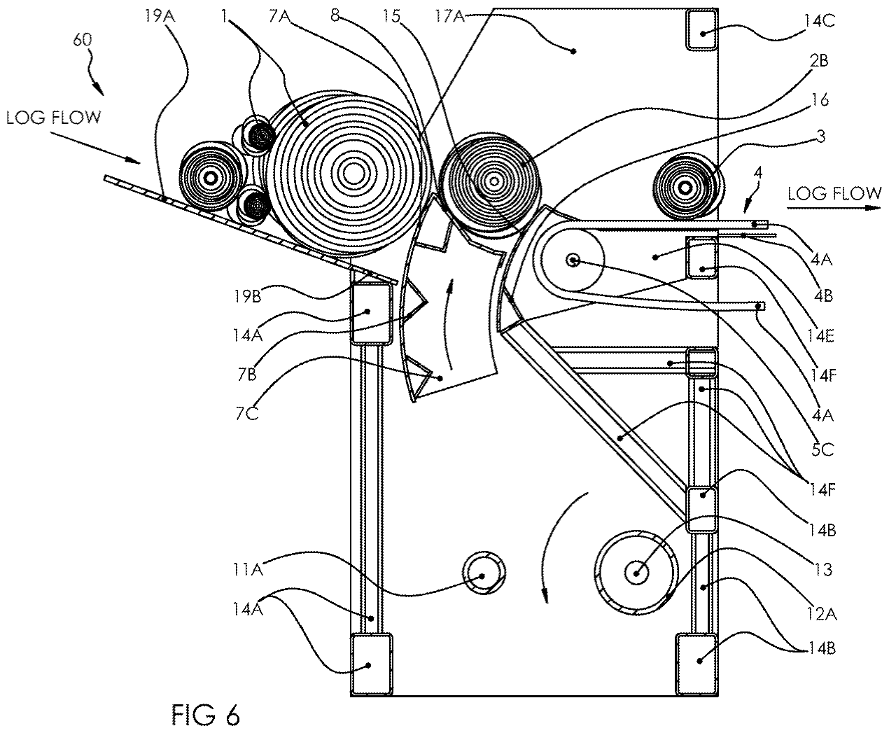

Log pusher 60 as herein described is built with no singulating cams or reinforcing strips on the faces of the radial barrier plates, as all surfaces needs to be smooth to allow the logs travelling longitudinally to slide along all log contacting surfaces. As seen in FIG. 6, front wall 7A functions to provide a continuous barrier when lifting log 2B from skid 19A/19B up to take-away deck 4. The front wall may thus function to inhibit wood debris from getting therethrough and into the interior of log pusher 60. Front wall 7A is smooth to allow for transverse log movement against the surface thereof.

The front wall includes a plurality of reinforcing members 7B. The reinforcing members coupled to and extend along the rear of front wall 7A. As seen in FIG. 5, reinforcing members 7B are longitudinally extending and L-shaped in cross-section in this example. The reinforcing members function to reinforce the working arc surface or front wall 7A and connect to elevating components 6A of lifting arms 6.

Referring back to FIG. 6, log pusher 60 includes a plurality of longitudinally spaced-apart and laterally/radially-extending stiffening plates 7C. The stiffening plates are generally co-extensive with elevating components 6A of lifting arms 6 seen in FIG. 5. Referring back to FIG. 6, stiffening plates 7C are positioned between the lifting arms, in this non-limiting example about two feet apart between the lifting arms. Reinforcing members 7B couple to stiffening plates 7C.

Log pusher 60 includes an upper elongate member, in this example an upper wall 8 which is part of the lifting device. The upper wall is longitudinally extending and couples to lifting arms 6 seen in FIG. 5 and stiffening plates 7C seen in FIG. 6. Referring to FIG. 3, upper wall 8 may be referred to as a log lifting surface or pusher face of the lifting arms, with log 2A on the pusher face being ready for lifting and about to be elevated. Alternatively, the upper wall may be referred to as a log-receiving top. Upper wall 8 is configured to accomodate either one large log or multiple smaller logs. The upper wall 8 is outwardly concave at least in part in this example, in this case comprising two angled portions that extend outwards from each other at an obtuse angle. As seen in FIG. 4, the upper wall contacts log 2B during the lifting stage. Log 2B is shown halfway up and is elevated by arc face or upper wall 8. The log is thereafter discharged smoothly onto the take-away deck tail end or plate 4B as seen in FIG. 5. Referring to FIG. 7, mechanism actuating arm 21 is configured to synchronously lift/lower the lifting arms 6, front wall 7A and upper wall 8. The upper wall is continuous and shaped to inhibit debris from passing therethrough.

The profile and location of lifting arms 6, including front wall 7A and upper wall 8 thereof, is thus designed to minimise debris accumulation during operation. Referring to FIG. 4, the geometry of the lifting arms is designed to relieve or create a gap between the log(s) 2B being lifted from the log(s) 1 left behind on hopper infeed skid 19A. Referring to FIG. 7, lifting arms 6 are profiled and positioned to efficiently resist impact loading and transfer forces into large pivot bearings 20.

Referring to FIG. 1, log pusher 60 includes a guiding barrier 15 that will now be described in further detail. The guiding barrier is longitudinally-extending. Guiding barrier 15 is shaped to inhibit debris from passing therethrough and therebetween. The guiding barrier in this example comprises a continuous arc-shaped barrier plate to locate logs 2A as seen in FIG. 3. Guiding barrier 15 is smooth to allow for transverse log movement against the surface thereof. The guiding barrier has a bottom 15A, a top 15B spaced-apart from the bottom thereof, and a front face or wall 15C extending from the bottom thereof to the top thereof. The front wall of guiding barrier 15 is continuous as seen in FIG. 1. Referring back to FIG. 3, front wall 15C of the guiding barrier is centered on the pivot axis of lifting arms 6 as depicted by pivot shaft 10A. Lifting arms 6, upper wall 8 and guiding barrier 15 are thus shaped to inhibit spacing therebetween, thus inhibiting the prospects of debris falling therebetween.

Front wall 15C of guiding barrier 15 includes a plurality of reinforcing members 16. The reinforcing members coupled to and extend along the rear of the front wall of guiding barrier 15. Reinforcing members 16 are longitudinally extending and L-shaped in cross-section in this example. The reinforcing members may be referred to as arc-shaped barrier plate reinforcing members. Reinforcing members 16 function to reinforce the working surface or front wall 15C of guiding barrier 15.

As seen with references to FIGS. 3 to 5, lifting arms 6 are moveable/rotatable or oscillate relative to guiding barrier 15. Where the term “rotary”, rotatably or the like is used, it is understood that the term oscillating or reciprocating may equally be applicable or substituted thereof. Upper wall 8 aligns with or is spaced above bottom 15A of guiding barrier 15 when lifting arms 6 are in their fully lowered position seen in FIG. 3. The upper wall is positioned towards or above top 15B of the guiding barrier when the lifting arms are in the fully raised position seen in FIG. 5. As seen with reference to FIGS. 3 to 5, the guiding barrier is adjacent to upper wall 8 throughout the range of motion of the upper wall and lifting arms 6.

Referring to FIG. 5, take-away deck plate 4B is longitudinally-extending and couples to and is integrally formed with front wall 15C of guiding barrier 15 in this example; however, this is not strictly required. The take-away deck plate may thus be said to be a part of the guiding barrier in this example. Take-away deck plate 4B is outwardly concave at least in part in this example, in this case comprising two angled portions that extend outwards from each other at an obtuse angle. As seen in FIG. 5, the take-away deck plate is shaped to receive log 2C discharged thereon and direct the log to take away deck 4.

Still referring to FIG. 5, log pusher 60 includes a plurality of longitudinally spaced-apart and laterally/radially-extending connecting plates 14E. The connecting plates couple to and extend radially inwards and downwards from front wall 15C of guiding barrier 15 and take-away deck plate 4B, respectively. Connecting plates 14E couple to and extend perpendicular to the guiding barrier and take-away deck plate in this example. The connecting plates are structural members that connect guiding barrier 15 to the main structure of log pusher 60, in this example coupling the guiding barrier to second truss assembly 14B.

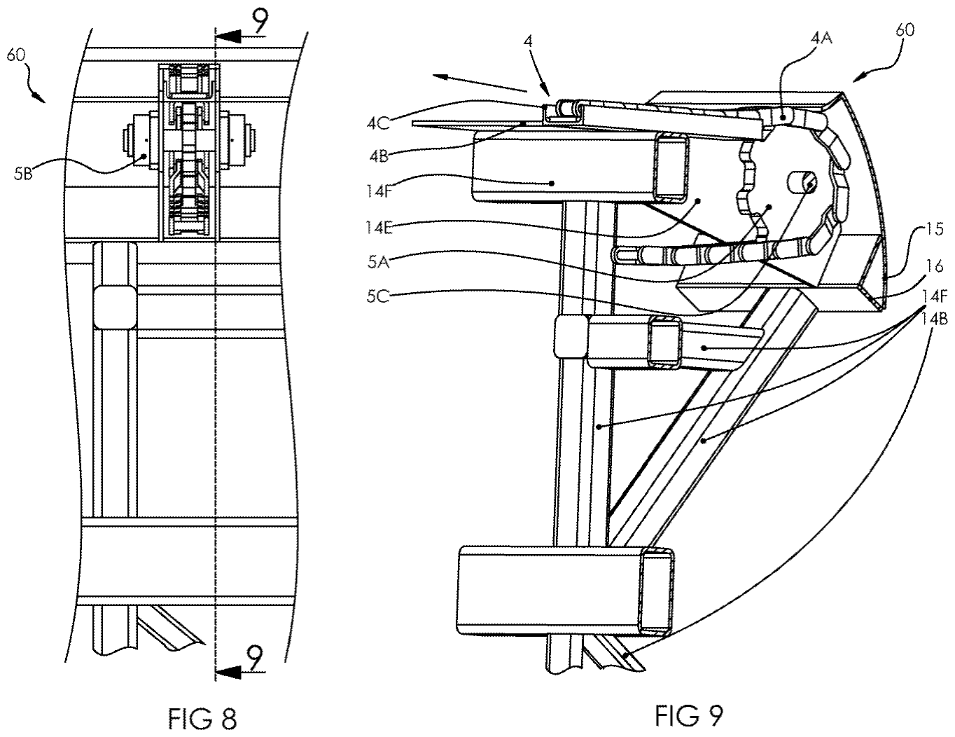

As seen in FIG. 9, an elongate member in this example a sprocket tail shaft 5C couples to and extends longitudinally outwards from opposed sides of one of connecting plates 14E. As seen in FIG. 8, log pusher 60 includes a pair of tail sprocket bearings 5B mounted to shaft 5C. Connecting plate 14E seen in FIG. 9 is shaped to receive or contain deck tail sprocket bearings seen in FIG. 8. Log pusher 60 includes a take-away deck tail sprocket 5A (seen in FIG. 9) rotatably supported by bearings 5B seen in FIG. 8. Shaft 5C seen in FIG. 9 thus supports the sprocket and rotating of the sprocket in the bearings. Referring back to FIG. 9, sprocket 5A is built into log pusher 60 for optimal log transfer onto take-away deck 4 in this example. The built in take-away deck tail sprocket may enable optimum log discharge geometry onto take-away deck 4 and maximise the take-away deck length. Built in tail sprocket 5A may also minimise the frame width of log pusher 60 by allowing the tail sprocket and pivot bearings seen in FIG. 1 to overlap.

Log pusher 60 includes take-away deck support members or beams, in this example in the form of a third truss-type structure or third truss assembly 14F. The third truss assembly couples to and extends laterally forwards from second truss assembly 14B and is positioned between end portions 64A and 64B of lower frame assembly seen in FIG. 1. Referring back to FIG. 9, third truss assembly 14F is generally triangular in this example. A diagonally-extending portion of the third truss assembly couples to guiding barrier 15 via reinforcing member 16 and extends in part perpendicular thereto in this example. A vertically extending portion of third truss assembly 14F couples to take-away deck plate 4B. The third truss assembly functions as a structure beam to support take-away deck 4 and stiffen the structure of log pusher 60. Guiding barrier 15 is reinforced by tail sprocket bearing plates to resist large horizontal log impact forces. Still referring to FIG. 9, an elongate channel, in this example a chain runner 4C abuts and extends along take-away deck plate 4B. The chain runner is a channel section that functions to receive or contain take-away deck chain 4A. The built in take-away deck 4 and tail sprocket 5A may promote optimum geometry for discharge of logs 3 from lifting arms 6 onto the transfer deck seen in FIG. 3.

Referring now to FIG. 5, counterbalance weight 11A of log pusher 60 will now be discussed in more detail. The counterbalance weight comprises a weight to provide a counterbalance moment to lifting arms 6. Counterbalance weight 11A is longitudinally extending and extends parallel to connecting bar 9 and pivot shaft 10A in this example. The counterbalance weight is in the form of an elongate member, in this example a shaft; however, this is not strictly required. Counterbalance weight 11A in this example couples to and extends between distal ends of a pair of laterally/radially extending and longitudinally spaced-apart counterbalance arms 11B. As seen in FIG. 3, counterbalance arms 11B are inwardly spaced from lifting arms 6, which in turn are adjacent to sides of log pusher 60 and respective bin walls 17A and 17B seen in FIG. 1. As seen in FIG. 7, distal ends of counterbalance weight 11A are positioned inwards of the distal ends of connecting bar 9 and pivot shaft 10A in this example.

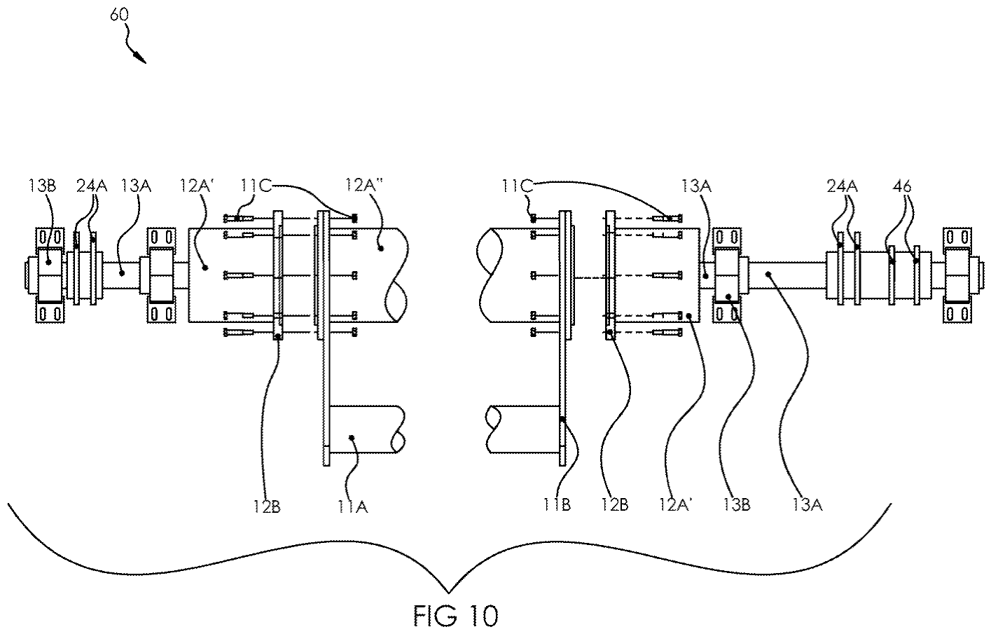

As seen in FIG. 10, log pusher 60 includes an equalizer, in this example an equalizer tube 12A that is longitudinally-extending. The equalizer tube is configured to transfer drive energy and motion from the drive side to the non-drive side mechanism of the log pusher. The equalizer tube is configured to promote synchronous motion of lifting arms 6. Equalizer tube 12A is positioned to enable an efficient statically balanced counterbalance weight 11A to be added to log pusher 60. The equalizer tube in this example comprises a plurality of parts or portions that are selectively connectable together for installation purposes: two outer portions 12A′ and a central portion 12A″. The central portion of the equalizer tube extends between counterbalance arms 11B and the outer portions of the equalizer tube are on opposed sides of the counterbalance arms. Each portion 12A′ of equalizer tube 12A includes a radially outwardly extending equalizer tube flange 12B connected thereto for operatively coupling to counterbalance weight 11A, with portion 12A″ of the equalizer including a pair of spaced-apart said equalizer tube flanges. Counterbalance arms 11B connect counterbalance weight 11A to equalizer tube 12A via proximal ends thereof. In this example each counterbalance arm 11B couples to equalizer tube flanges 12B of respective portions 12A′ and 12A″ of equalizer tube 12A via fasteners, in this example nuts and bolts 11C. Counterbalance portion 12A″ of equalizer tube 12A is thus bolted into the equalizer tube at each end with bolting joints. Equalizer tube 12A so made in sections bolted together, enables the complete counterbalance weight 11A to be removed and installation of the assembled tube eased. Nuts and bolts 11C may thus function to selectively connect together the equalizer tube during assembly as well as selectively disconnect the same for repairs and the like.

As seen in FIG. 7, log pusher 60 includes an equalizer tube shaft 13A. The equalizer tube shaft couples to, is coaxial with and extends axially outwards from portions 12A′ of equalizer tube 12A. As seen in FIG. 3, the equalizer tube shaft is laterally spaced-apart from and extends parallel to connecting bar 9 and pivot shaft 10A. As seen in FIG. 1, equalizer tube shaft 13A pivotally couples to truss assembly 14A and lower frame assembly 62 via plurality of longitudinally spaced-apart equalizer tube bearings 13B extending along the rear of log pusher 60 in this example. As seen in FIG. 7, the equalizer tube shaft is the shaft around which the equalizer tube, counterbalance arms 11B and counterbalance weight 11A pivot on bearings 13B.

As seen in FIGS. 3 to 5, the counterbalance weight oscillates or reciprocates about a pivot axis (as defined by equalizer tube 12A) aligned with or forward of pivot axis (as defined by pivot shaft 10A) of lifting arms 6. However, this is not strictly required and the counterbalance weight may be positioned rearward of the pivot axis of the lifting arms in other embodiments. The lifting arms and counterbalance weight substantially align vertically with each other in this non-limiting example. Counterbalance weight 11A and counterbalance arms 11B have a first or fully lowered position seen in FIG. 5. The counterbalance weight is adjacent the bottom of log pusher 60 when the counterbalance weight and counterbalance arms are in the fully lowered position in this example. Lifting arms 6 are in their fully raised positions when counterbalance weight 11A and counterbalance arms 11B are in their fully lowered position in this example.

As seen with reference to FIGS. 3 to 5, counterbalance weight 11A extends upwards towards lifting arms 6 as the lifting arms lower, and the counterbalance weight moves away from the lifting arms as the lifting arms rise. As seen in FIG. 3, counterbalance weight 11A and counterbalance arms 11B have a second or fully raised position. The counterbalance weight is spaced-apart from the bottom of log pusher 60 in the fully raised position thereof. Lifting arms 6 are in their fully lowered positions when counterbalance weight 11A and counterbalance arms 11B are in their fully raised positions in this example. The lifting arms in the lowered position thereof are shaped to receive at least in part and/or overlap with the counterbalance weight in the raised position of the counterbalance weight. As seen with reference to FIGS. 3 and 7, load carrying lifting arms 6 are attached to connecting bar 9 along distal ends of the connecting bar at each side of upper wall 8. This enables counterbalance weight 11A and counterbalance arms 11B to selectively move at least in part within the enclosure formed by the lifting arms and front wall 7A. The travel distance of counterbalance weight 11A as seen in FIGS. 3 to 5, is so configured to maximize its travel distance so as to minimize the counterbalance weight.

As seen in FIG. 1, log pusher 60 includes a drive or driving mechanism, in this example an external, radial actuating driving mechanism 39 which will now be described in more detail. The driving mechanism is positioned external to truss assemblies 14A and 14B, bin walls 17A and 17B and counterbalance weight 11A. Driving mechanism 39 operatively couples to and actuates (continuously and/or intermittently) connecting bar 9 and pivot shaft 10A so as to reciprocate lifting arms 6, front wall 7A and upper wall 8 through a curved range of motion spanning from fully lowered to fully raised positions as seen in FIGS. 3 to 5. The driving mechanism thus operatively connects to and reciprocates the lifting arms, front wall and upper wall through a range of motion spanning from fully lowered to fully raised positions. Driving mechanism 39 seen in FIG. 1 also operatively connects to and reciprocates counterbalance weight 11A and counterbalance arm 11B through a range of motion spanning from the fully lowered position thereof seen in FIG. 5, to fully the fully raised position thereof seen in FIG. 3. As seen in FIG. 3, lifting arms 6 and counterbalance weight/arms 11A and 11B are configured to oscillate in opposite directions from one another via driving mechanism 39.

The following is a non-limiting example of one such driving mechanism and associated linking mechanism that enables the above functionality. However, one skilled in the art will appreciate that other means of achieving the above range of motion and configured are possible in other embodiments.

As seen in FIG. 1, driving mechanism 39 is positioned between the front and rear of log pusher 60 in this example. The driving mechanism includes an actuator in this example a motor, in this case an electric motor 40; however, this is not strictly required and other types of actuators or motors may be used in other embodiments. The electric motor is configured for lifting and is the main motor for driving log pusher 60. Driving mechanism 39 includes a gear box 41 operatively connected to electric motor 40. The gear box is configured for lifting and is the main gear box for driving log pusher 60. Gearbox 41 includes a drive mounting shaft 42, which is a shaft for mounting the drive. The drive mounting shaft is longitudinally extending and extends parallel with connecting bar 9 and pivot shaft 10A in this example. Drive mounting shaft 42 rotatably couples to end portion 64B of lower frame assembly 62 via a pair of spaced-apart drive shaft support bearings 43, which function to support the shaft and drive.

As seen in FIG. 7, driving mechanism 39 includes a crank arm, in this example an eccentric crank arm 44 coupled to and extending radially outwards from shaft 42. The driving mechanism includes a primary drive connecting rod 45, with a proximal end thereof rotatably coupling to a distal end of the crank arm (e.g. via a pin and bearing). Crank arm 44 functions to provide oscillating or reciprocating motion to the connecting rod. Driving mechanism 39 includes a primary actuating arm 46 coupled to and radially extending outwards from equalizer tube shaft 13A. The actuating arm pivotally couples to drive connecting rod 45 via connecting pin 28A. The connecting pin transmits the motion from the drive connecting rod to primary actuating arm 46 on equalizer tube shaft 13A. The primary actuating arm is driven by connecting rod 45 to actuate the equalizer tube shaft.

As seen with reference to FIGS. 2 and 7, driving mechanism 39 includes a pair of longitudinally spaced-apart second actuating arms 24A. Each second actuating arm couples to and extends radially outwards from equalizer tube shaft 13A.

As seen in FIGS. 2 and 7, driving mechanism 39 includes a pair of longitudinally spaced-apart reversing rotation shafts 26. Each shaft is longitudinally-extending and extends parallel to drive mounting shaft 42, connecting bar 9, equalizer tube shaft 13A and pivot bar 10A in this example. Reversing rotation shafts 26 couple to end portions 64A and 64B of lower frame assembly 62 seen in FIG. 2, via a pair of spaced-apart reverse rotation bearings 27. The bearings function to support the reversing rotation shaft. As seen in FIG. 7, each reversing rotation shaft 26 includes a first actuating arm 24B coupled to and radially extending outwards therefrom. Each aligned pair of actuating arms 24A and 24B are linked together via a respective reversing direction connecting rod 25 that rotatably couples to distal ends of the actuating arms via connecting pins 28B. The pins transmit the motion from actuating arm 24A on equalizer tube shaft 13A to corresponding actuating arm 24B on corresponding reversing rotation shaft 26.

The reversing rotation shafts operatively couple to lifting arms 6, front wall 7A and upper wall 8. In this example and referring to FIG. 7, each reversing rotation shaft 26 includes a second actuating arm 23 coupled thereto and radially extending outwards therefrom. Aligned pairs of actuating arms 21 and 23 are linked together via a corresponding said lifting arm push/pull rod 22. Each lifting arm push/pull rod functions to transfer corresponding actuating arm motion to lifting arms 6, front wall 7A and upper wall 8. Each lifting arm push/pull rod 22 rotatably couples to the distal end of its corresponding actuating arm 23 via connecting pin 28C. Each lifting arm push/pull rod rotatably couples to its corresponding actuating arm 23 at location between connecting bar 9 and pivot shaft 10A and via connecting pin 28C. The pins transmit the motion from actuating arms 23 on reversing rotation shafts 26 to lifting arm push/pull rods 22. Actuating arms 23 thus function to elevate and lower lifting arms 6, front wall 7A and upper wall 8 and also function to reverse the equalizer tube direction.

As seen in FIG. 2 and mentioned above, there is a parallel set of actuating arm 21, lifting arm push/pull rod 22, actuating arms 24A and 24B, reversing direction connecting rod 25, reversing rotation shaft 26, and reversing rotation bearings 27 positioned and mounted to end portion 64B of lower frame assembly 62 and external to bin wall 17A.

Referring back to FIG. 1, driving mechanism 39 so positioned and as herein described may provide a number of benefits over known prior art systems. The drive mechanism as herein described relocates the normally located internal drive/lifting components to the outside to provide space for counterbalance weight 11A and counterbalanc arm 11B seen in FIG. 3. Referring to FIG. 7, drive mechanism 39 so externally positioned enables log pusher 60 to include a low cost said internal counterbalance weight to be connected to equalizer tube 12A, with the direction of the equalizer tube being reversed by the lifting mechanism. Log pusher 60 as herein described may thus minimize internal structural members except for equalizer tube 12A and counterbalance weight 11A.

Driving mechanism 39 so externally positioned may also allow for the optimization of the lifting mechanism geometry. The driving mechanism so located may free up space to conveniently add additional shafts and actuating arms at each end of log pusher 60 to provide reversing motion for lifting arms 6.

Referring to FIG. 1, driving mechanism 39 so positioned locates drive and mechanism point loads to be outside of bin walls 17A and 17B for a free spanning design and convenient structural support design.

The driving mechanism so externally positioned may minimize barriers to debris falling into the clean-up conveyor below and may function to inhibit or eliminate the ability of vines to entangle the drive/mechanism. The driving mechanism so positioned may function to inhibit or eliminate debris hang-up on the drive, mechanism and structural support, thereby reducing clean-up requirements. The main debris exit route from log pusher 60 may thus be free of impediments, and the secondary debris exit routes may thus be easily/readily cleaned. Internal lifting arms 6 seen in FIG. 7 and as herein described are profiled to optimize log impact load resistance, the load transfer back to the bearings, and debris removal.

Driving mechanism 39 so externally positioned may function to inhibit or eliminate impact loading from logs on the mechanism. The driving mechanism so externally positioned promotes easy access thereto for repair and replacement of wear components. Driving mechanism 39 so positioned facilitates visable mechanism function and may provide convenient access to lubrication points. The driving mechanism so externally positioned may enable several drive location options to suit the site circumstances.

It will be appreciated that many variations are possible within the scope of the invention described herein. For example, A single acting log pusher has been described herein. However, this is not strictly required a double acting log pusher that is naturally balanced may be provided in other embodiments with similar process results, but at a higher cost and more complexity. The capacity of a single acting log pusher may be slightly higher. This is because when logs are on top of one another at the barrier surface to be elevated, both logs go up together and are only separated when spilling onto the take-away deck.

Where a component (e.g. a member, apparatus, assembly, device etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

Alternatively, instead of what is described above, the control system for log pusher 60 may be non-existent or simple. For example, in one non-limiting example, the control system may comprise one photocell to detect when a log is present at the bottom of the skid and resting against the face of the lifting arm 6, with the log pusher continuing to operate until there is no log present.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:

in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A log processing assembly comprising:
an elongate member;
a lifting device which couples to and extends radially outwards from the elongate member;
a pair of spaced-apart wall members between which the lifting device extends; and
an external, radial actuating driving mechanism which operatively connects to and actuates the elongate member so as to reciprocate the lifting device through a curved range of motion spanning from lowered to raised positions, the driving mechanism being positioned external to said wall members.

2. A log processing device as claimed in claim 1 wherein at least one of the wall members has an aperture or an opening shaped to receive an end portion of the elongate member therethrough, the end portion of the elongate member being external to said wall members, and the driving mechanism coupling to the end portion of the elongate member.

3. A log processing device as claimed in claim 1, wherein at least one of the wall members has one or more of an aperture, an opening and an arc-shaped slot shaped to receive an end portion of the elongate member therethrough, the one or more of the aperture, the opening and the arc-shaped slot having a radius of curvature, wherein the lifting device rotates about a pivot point and wherein the distance between a center of the elongate member and the pivot point is substantially equal to said radius of curvature.

4. A log processing device as claimed in claim 1, wherein the at least one said wall member has an arc-shaped slot and includes a pair of spaced-apart end portions in communication with the slot, with the elongate member being adjacent a lower said end portion of the at least one said wall member when the lifting device is in the lowered position and with the elongate member being adjacent an upper said end portion of the at least one said wall member when the lifting device is in the raised position.

5. A log processing device as claimed in claim 1, wherein the lifting device includes two or more spaced-apart arms extending perpendicular and coupling to the elongate member, an outwardly concave front face extending parallel to the elongate member, and a log-receiving top extending parallel to the elongate member, with each said arm being U-shaped in side profile and comprising two parts which are connectable together.

6. A log processing device as claimed in claim 1, wherein the log processing device includes a guiding barrier adjacent to a log-receiving top of the lifting device throughout the range of motion of the log-receiving top, and wherein one or more of: the guiding barrier has a continuous front face; and; the guiding barrier is shaped to inhibit debris from passing therethrough and therebetween; and the lifting device selectively rotates about a pivot axis and a front face of the guiding barrier is centered on the pivot axis of the lifting device.

7. A log processing device as claimed in claim 1, including a guiding barrier having a bottom, having a top spaced-apart from the bottom thereof, and including a front face extending between the bottom thereof and the top thereof, the front face of the guiding barrier being continuous, and the lifting device being moveable relative to the guiding barrier, with a log-receiving top of the lifting device aligning with or being spaced above the bottom of the guiding barrier when the lifting device is in the lowered position and with the log-receiving top of the lifting device being positioned towards or above the top of the guiding barrier when the lifting device is in the raised position.

8. A log processing assembly comprising:
a pair of spaced-apart wall members;
one or more truss-type structures coupled to and extending between the wall members;
a lifting device coupled to, extending between and moveable relative to the wall members; and
a driving mechanism which operatively connects to and reciprocates the lifting device through a range of motion spanning from lowered to raised positions.

9. A log processing assembly according to claim 8, wherein the log processing assembly is configured to be freestanding and wherein one or more of: the log processing assembly includes spaced-apart end portions that are load-bearing and between which extend the one or more truss-type structures; and the driving mechanism is positioned external to said wall members and external to the one or more truss-type structures.

10. A log processing assembly according to claim 8, including a lower frame assembly to which the one or more truss-type structures and the wall members couple and extend upwards therefrom.

11. A log processing assembly according to claim 10, wherein the log processing assembly includes a first said truss-type structure coupled to a front of the lower frame assembly, wherein the log processing assembly includes a second said truss-type structure spaced-apart from the first said truss-type structure, the second said truss-type structure coupling to a rear of the lower frame assembly, and wherein the wall members couple to and extend between the front and the rear of the lower frame assembly.

12. A log processing assembly comprising:
a driving mechanism; and
a lifting device and a counterweight configured to oscillate in opposite directions from one another via the driving mechanism, with the counterweight rotating about an axis parallel to and spaced-apart from an axis of rotation of the lifting device.

13. A log processing assembly according to claim 12, wherein the counterweight is configured to move towards the lifting device when the lifting device is being lowered and wherein the counterweight is configured to move away from the lifting device when the lifting device is being raised.

14. A log processing assembly according to claim 12, wherein the axis of the counterweight is positioned below the axis of rotation of the lifting device.

15. A log processing assembly according to claim 12, wherein the counterweight is positioned forward of the axis of rotation of the lifting device.

16. A log processing assembly according to claim 12, wherein the lifting device includes a pair of spaced-apart arms and an equalizer configured to promote synchronous motion of the arms, wherein the counterweight couples to the equalizer and wherein the equalizer is one or more of: longitudinally-extending and a tube.

17. A log processing assembly according to claim 12, wherein the log processing assembly comprises three separate sub-assemblies which are selectively connectable together and in the form of:
i) the driving mechanism coupled to a first end portion of the log processing assembly;
ii) a non-driving mechanism coupled to a second end portion of the log processing assembly; and
iii) an equalizer coupled to and extending between the driving mechanism and the non-driving mechanism, the equalizer promoting synchronous motion of spaced-apart arms of the lifting device, and the counterweight coupling to the equalizer.

18. A log processing assembly according to claim 12, wherein one or more of:
the counterweight is adjacent a bottom of the log processing assembly when the counterweight is in a lowered position;
the lifting device in the lowered position is shaped to receive at least in part the counterweight in a raised position of the counterweight;
a log lifting surface of the lifting device substantially aligns vertically with the counterweight throughout the range of motion of the lifting device and the counterweight; and
the counterweight is positioned adjacent or below the lifting device through the range of motion of the lifting device and the counterweight.

19. A log processing assembly according to claim 12, wherein the lifting device includes a pair of spaced-apart and coupled together arms, wherein the counterweight includes a pair of spaced-apart arms and an elongate member coupled thereto and extending therebetween, with the arms of the counterweight being inwardly spaced from the arms of the lifting device.

20. A log processing assembly according to claim 12, wherein the driving mechanism is external to the lifting device and the counterweight.
